(19) United States
(12) Patent Application Publication
(10) Pub. No.: US 2018/0177178 A1
(43) Pub. Date: Jun. 28, 2018

(54) Animal Deterrent Apparatus

(71) Applicants: Ria Bhakta, Saratoga, CA (US); Kate Hsiung, Saratoga, CA (US); Nidhi Mathihalli, Saratoga, CA (US); Olivia Neal, Saratoga, CA (US); Elizabeth Stoiber, Saratoga, CA (US); Samantha Stoiber, Saratoga, CA (US)

(72) Inventors: Ria Bhakta, Saratoga, CA (US); Kate Hsiung, Saratoga, CA (US); Nidhi Mathihalli, Saratoga, CA (US); Olivia Neal, Saratoga, CA (US); Elizabeth Stoiber, Saratoga, CA (US); Samantha Stoiber, Saratoga, CA (US)

(21) Appl. No.: 15/817,287

(22) Filed: Nov. 20, 2017

Related U.S. Application Data
(60) Provisional application No. 62/437,993, filed on Dec. 22, 2016.

(51) Int. Cl. A01M 29/16; A01M 31/00; G06K 9/00; G06K 9/62

(52) U.S. Cl. CPC A01M 29/16; A01M 31/002; A01K 29/005; G06K 9/6202; G06K 9/00362

(57) ABSTRACT

This disclosure provides an apparatus and method for detecting and repelling animals. In some implementations, possible animal activity is first detected through thermal and motion detection. After possible animal activity is detected, then an image capturing system captures and analyzes a plurality of images to verify the presence of an animal. If the presence of an animal is verified, then an audio file is played through a speaker to startle and repel the animal.

### TECHNICAL FIELD

This disclosure relates generally to devices for animal behavior modification, and specifically to an animal deterrent apparatus.

### DESCRIPTION OF THE RELATED TECHNOLOGY

People may temporarily or permanently inhabit areas that are shared with many types of wildlife. For example, hikers and backpackers may trek into wilderness areas for daytrips or for extended excursions. While in these wilderness areas, animals may be attracted to camp or picnic sites, especially if they are unattended and have a cache of food or other human scented articles. Animals should be repelled from these areas to protect the animals from ingesting any human food which may be detrimental to the animal's health.

In another example, human residential areas may be rural and, in some cases, may encroach upon active animal areas. Some houses may have gardens that feature plants that are attractive to different animals. The animals feeding on, and otherwise damaging these gardens may be considered nuisance animals. Tenants of these houses may want to prevent the damage brought about by the animals.

Fencing off areas to keep animals away may not be feasible. In some instances, the human presence may be transitory and a permanent fixture to repel animals may not be practical. Further, an animal may be hurt by a fence. Thus, there exists a need for a humane approach to deter animals from certain areas.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

An apparatus is disclosed that may detect and deter an animal. In a first example, an animal deterring apparatus may include a first subsystem to detect heat and motion within a predetermined distance of the apparatus, a second subsystem to verify an animal presence via an image processing subsystem in response to the detection of heat and motion, and a third subsystem to repel an animal by a playback of audio files in response to the verification of an animal presence.

In another example, a method is disclosed to detecting and repelling animals and may include detecting heat and motion, verifying an animal presence via an image processing subsystem in response to detecting heat and motion, and repelling an animal by playing back audio files in response to verifying an animal presence.

In another example, a method is disclosed to verify an animal presence that may include capturing a first and a second image, determining a difference image based on the first and the second images; and determining an outline length based on similarly valued adjacent pixel of the difference image.

### BRIEF DESCRIPTION OF THE DRAWINGS

Aspects of this disclosure are illustrated by way of example, and not by way of limitation, in the figures of the accompanying drawings and in which like reference numerals refer to similar elements.

FIG. 1 depicts a block diagram of an example animal deterrent device.

FIG. 2 shows an illustrative flow chart depicting an operation for operating the animal deterrent device of FIG. 1.

FIG. 3 shows an illustrative flow chart depicting an operation for capturing and processing images.

FIG. 4 shows an illustrative flow chart depicting an operation for activating an animal deterrent.

FIG. 5 shows an illustrative flow chart depicting an operation for processing images and determining an animal presence.

FIG. 6 shows an illustrative flow chart depicting an operation 600 for determining an image outline metric

FIGS. 7A-7C show example images to illustrate processing associated with the operation for determining the image outline metric of FIG. 6.

FIGS. 8A-8C show more example images to illustrate the processing associated with the operation for determining the image outline metric of FIG. 6

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways.

Implementations of the subject matter described in this disclosure may be used to repel animals. An apparatus for repelling animals may be triggered by a detection of heat and motion. After being triggered, a presence of an animal may be verified. In some implementations, an image capture subsystem may capture and process a plurality of images to verify the presence of one or more animals. In response to the verification of the presence of the one or more animals, an audio file may be selected and reproduced to scare or startle the animal.

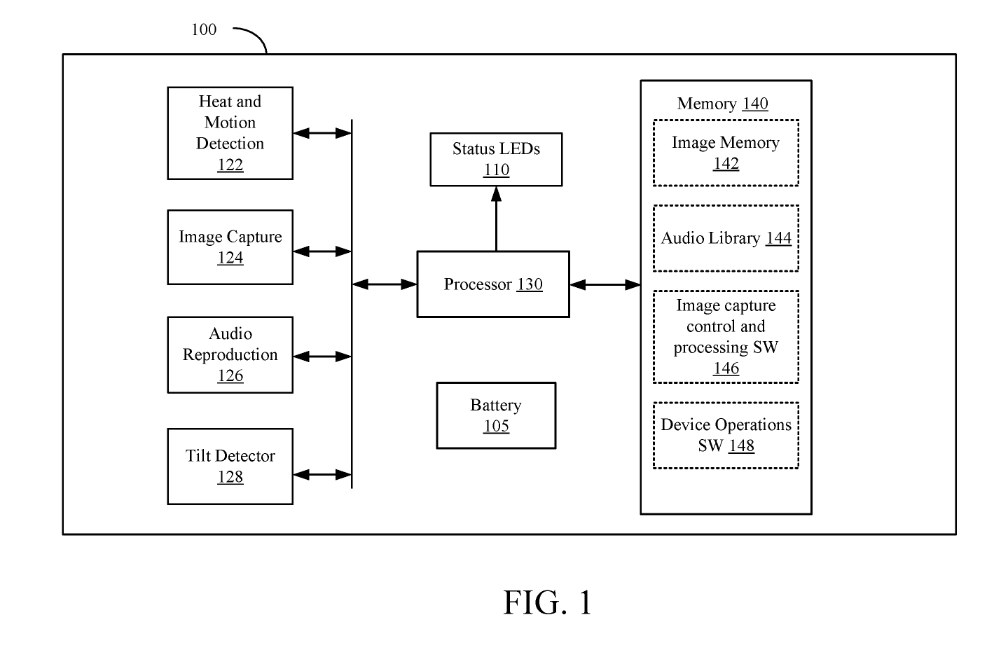

FIG. 1 depicts a block diagram of an example animal deterrent device 100. The animal deterrent device 100 may include a battery 105, status light emitting diodes (LEDs) 110, a heat and motion detection subsystem 122, an image capture subsystem 124, an audio reproduction subsystem 126, a tilt detector 128, a processor 130, and a memory 140.

The battery 105 may provide power for some or all of the subsystems of the animal deterrent device 100. In some implementations, the battery 105 may be rechargeable and/or may be replaced by a power supply capable of converting alternating current (AC) power into a suitable power for the animal deterrent device 100.

The status LEDs 110 may be coupled to the processor 130 and may indicate operating states or modes of the animal deterrent device 100. In some implementations, the status LEDs 110 may be disabled to conserve power or to help hide the location of the animal deterrent device 100.

The heat and motion detection subsystem 122 may provide an initial indication of the presence of an animal. For example, the heat and motion detector subsystem 122 may detect heat and/or motion of an object within a predetermined distance of the animal deterrent device 100. In some aspects, the heat and motion detection subsystem 122 may include one or more active and/or passive sensors. For example, the heat and motion detection subsystem may include active sensors that emit (and detect reflections of) ultrasonic or microwave energy. In another example, the heat and motion detection subsystem 122 may include passive sensors that detect changes in infrared radiation. Passive sensors may advantageously consume less power and extend battery life. The heat and motion detection subsystem 122 may allow the animal deterrent device 100 to operate in a low-power mode until the detection of some activity. Thus, the detection of heat and/or motion may be used operate the animal deterrent device 100 in a regular power mode. In the regular power mode, the animal deterrent device 100 may verify the presence of, and repel animals.

The image capture subsystem 124 may capture one or more images that may be stored in the memory 140. The stored images may be processed to verify the presence of an animal. In some implementations, the image capture subsystem 124 may include a digital camera or image sensor (not shown for simplicity) that may be sensitive to visible and/or infrared light. In addition, the image capture subsystem 124 may include may include an ambient light sensor and infrared or visible light sources (also not shown for simplicity). The ambient light sensor may detect low light conditions and, in response to low light situations, the infrared and/or visible light sources may be turned on to enhance the performance of the digital camera or image sensor.

In some implementations, the image capture subsystem 124 may capture a first and a second image. A sum of an absolute value of the difference in the gray scale values between pixels in the same (pixel) location, but located in different images (frames) is computed. If the sum exceeds a predetermined (and in some cases empirically derived) threshold, then the image capture subsystem 124 may assert a first signal to the processor 130 to confirm the presence of an animal. On the other hand, if the sum does not exceed the threshold, the image capture subsystem 124 may not assert the first signal to the processor 130 to indicate the absence of an animal. In some implantations, the image capture subsystem 124 may assert a second signal (different from the first signal) to indicate the absence of an animal.

The audio reproduction subsystem 126 may include one or more speakers and/or amplifiers (not shown for simplicity) to playback a selected audio file. In some implementations, the audio reproduction subsystem 126 may include a microphone to determine an ambient noise level. The audio reproduction subsystem 126 may set a playback volume level based at least in part on the ambient noise level.

The tilt detector 128 may be used to determine motion of the animal deterrent device 100. In some implementations, the tilt detector 128 may be firmly affixed to the animal deterrent device 100. Therefore, and motion (tilt) detected by the tilt detector 128 may indicate motion of the animal deterrent device 100. The motion, for example, may be caused by animals moving or otherwise disturbing the animal deterrent device 100. Some embodiments of the tilt detector 128 may include a metal ball that may make and break contact between conductive leads. Other embodiments of the tilt detector 128 may include gyroscopic and/or acceleration sensors.

The memory 140 may include an image memory 142 that may store images, including digital images that may be captured by the image capture subsystem 124. In some implementations, the stored images may be compressed or non-compressed and arranged in image frames where each image frame contains a plurality of pixels.

The memory 140 may also include an audio library 144 that can store one or more audio files that may be played back through the audio reproduction subsystem 126. In some implementations, the processor may randomly select an audio file to be played through the audio reproduction subsystem 126. In other implementations, the user may select one or more specific audio files to reproduce after an animal presence is verified.

Further, the memory 140 may also include a non-transitory computer-readable storage medium (e.g., one or more nonvolatile memory elements, such as EPROM, EEPROM, Flash memory, a hard drive, etc.) that may store the following software modules:
an image capture control and processing software (SW) module 146 to control image captures through the image capture subsystem 124 and process the images captured and stored in the image memory 142; and
a device operation SW module 148 to control one or more operations associated with the animal deterrent apparatus 100.

Processor 130, which is coupled to heat and motion detection subsystem 122, the image capture subsystem 124, the audio reproduction subsystem 126, the status LEDs 110, and the memory 140, may be any one or more suitable processors capable of executing scripts or instructions of one or more software programs stored within the memory 140.

Processor 130 may execute the image capture control and processing SW module to process images from the image capture subsystem 124. In some implementations, the image capture control and processing SW module 146 may receive one or more images from the image capture subsystem 124 and store them in the image memory 142. Execution of the image capture control and processing SW module 146 may also determine a sum of an absolute value of the difference in the gray scale values between pixels in the same (pixel) location, but located in different stored images (frames). If the sum exceeds a predetermined (and in some cases empirically derived) threshold, then the presence of an animal may be verified. On the other hand, if the sum does not exceed the threshold, the presence of an animal may not be verified. Execution of the image capture control and processing SW module 146 may also detect amounts of ambient light though light sensors included in the image capture subsystem 124 and may turn on one or more visible or infrared lights also included in the image capture subsystem 124. In some implementations, execution of the image capture control and processing SW module 146 may also monitor output signals from the tilt detector 128 to determine whether the animal deterrent device 100 may have been moved. Motion of the animal deterrent device 100 may indicate a presence of an animal. In some implementations, the image capture subsystem 124 and the image capture control and processing SW module 146 may operate together as an image processing subsystem.

The processor 130 may execute the device operation SW module 148 control one or more operations of the animal deterrent device 100. In some implementations, execution of the device operation SW module 148 may determine operating modes of the animal deterrent device 100. For example, the animal deterrent device 100 may be in a low-power mode until the heat and motion detector subsystem 122 detects heat and/or motion. In response to the detection of heat and or motion, the processor 130 may cause the animal deterrent device 100 to operate in a normal power mode and execute the image capture control and processing SW module 146. If an animal is detected, the processor 130 may play an audio file through the audio reproduction subsystem 126.

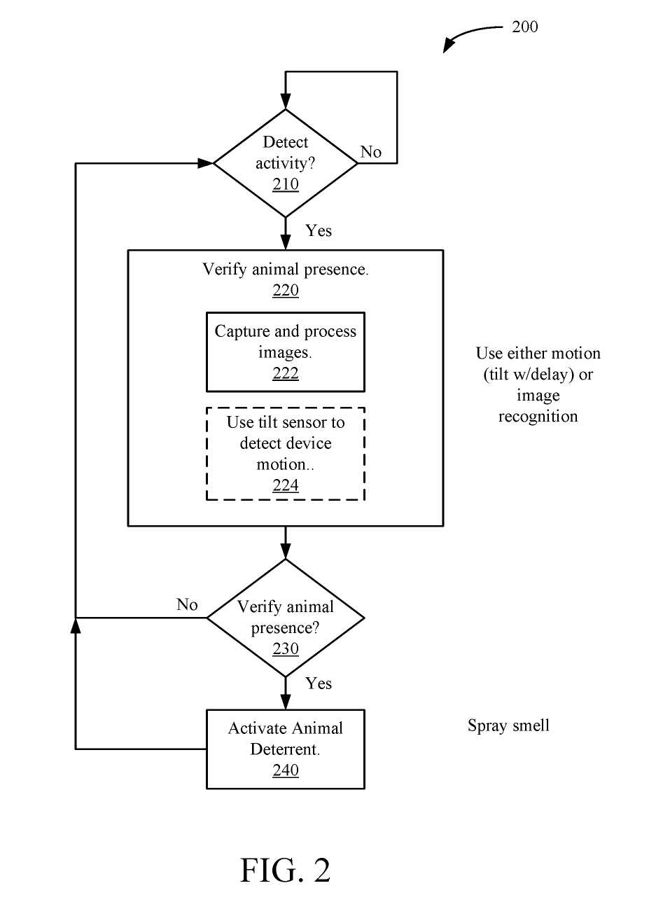

FIG. 2 shows an illustrative flow chart depicting an example operation 200 for operating the animal deterrent device 100 of FIG. 1. Although described herein as being performed by the animal deterrent device 100 of FIG. 1, the operation 100 may be performed by any other suitable device. Referring also to FIG. 1, the operation 200 begins as the animal deterrent device 100 determines if activity is detected (210). In some implementations, the heat and motion detection subsystem 122 may detect activity within a predetermined distance of the animal deterrent device 100. For example, the heat and motion detection subsystem 122 may use active and/or passive motion sensors to detect nearby activity to the animal deterrent device 100. In another example, the heat and motion detection subsystem 122 may use heat (thermal) sensors to detect nearby activity. If no activity is detected, then the operation returns to 210.

If, on the other hand, activity is detected, then the animal deterrent device 100 verifies the presence of an animal (220). In some implantations, the animal deterrent device 100 may capture and process images (222) to verify the presence of an animal. For example, the image capture subsystem 124 may capture a plurality of images. The captured images may be stored in the image memory 142. In some aspects, the processor 130 may execute the image capture control and processing SW module 146 to compare images stored in the image memory 142 and determine whether the images are associated with an animal (verify the presence of an animal).

In addition, or alternatively, the animal deterrent device 100 may use the tilt detector 128 to detect motion of the animal deterrent device 100 (224). (This optional step illustrated with dashed lines.) Since the tilt detector 128 may be affixed to the animal deterrent device 100, any motion (tilt) detected by the tilt detector 128 may indicate movement of the animal deterrent device 100, possibly caused by an animal.

If the presence of an animal is verified (as tested at 230), then an animal deterrent is activated (240). In some implementations, an audio file may be selected from an audio library 144 and reproduced (played back) through the audio reproduction subsystem 126. In some other implementations, a microphone or other sound sensing device may be used to determine a volume level for the audio file. The operation returns to 210. In still other implementations, an offensive scent may be deployed to repel a variety of animals.

If the presence of the animal is not verified (as tested at operation 230), then the operation returns to 210. For example, if during the operation to verify animal presence 220 the processed images do not indicate that an animal is present, then the operation may return to 210 to begin the operation 200 again.

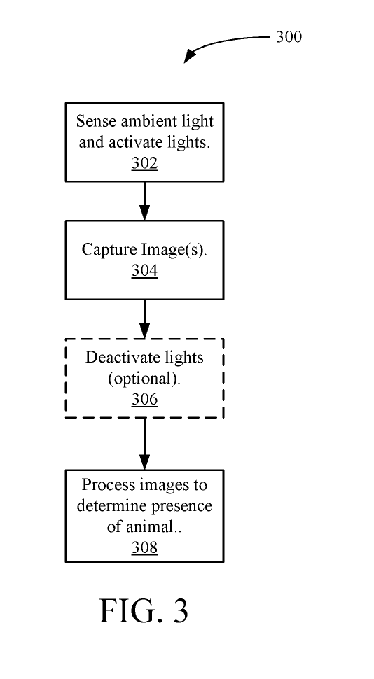

FIG. 3 shows an illustrative flow chart depicting an operation 300 for capturing and processing images. In some implementations, the operation 300 may be associated with, or be related to, the operation to capture and process images 222 of FIG. 2. Referring also to FIG. 1, operation 300 may begin as an ambient light sensor detects ambient light and activates light sources (302). An ambient light sensor, included in the image capture subsystem 124, may detect levels of ambient light near the animal deterrent device 100. If the ambient light is less than a threshold, the light sources, also included in the image capture subsystem 124, may be turned on to provide visible and/or infrared light. On the other hand, if the ambient light is greater than the threshold, then the light sources may remain off.

Next, two or more images may be captured (304). In some implementations, the image capture subsystem 124 may capture and store at least two images in the image memory 142. A time period may elapse between the captured images. For example, a first image may be captured, then after a predetermined time period a second image may be captured.

Next, lights are deactivated (306). If the light sources were turned on (with respect to 302), then the lights may be turned off during this operation. For example, the images were captured in 304, and therefore the light sources are no longer necessary. Images may be processed to determine the presence of an animal (308). In some implementations, the image capture subsystem 124 may determine a sum of an absolute value of the difference between pixel values of the same (pixel) location, but located in different images (frames) and compare the sum to a threshold to determine whether an animal is present.

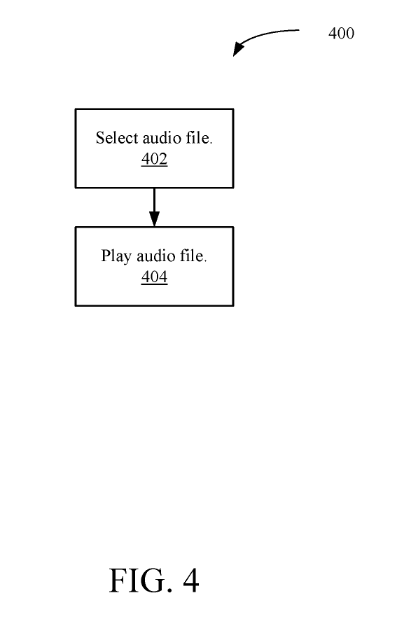

FIG. 4 shows an illustrative flow chart depicting an example operation 400 for activating an animal deterrent. In some implementations, the operation 400 may be associated with, or be related to, the operation to active an animal deterrent 240 of FIG. 2. Referring also to FIG. 1, an audio file is selected (402). In some implementations, the audio reproduction subsystem 126 may randomly select an audio file from the audio library 144. In some other implementations, the user may select one or more audio files from the audio library. Next, the selected audio file may be played back (404). In some implementations, the audio reproduction subsystem 126 may determine the volume level of the reproduced audio file based at least in part by an ambient sound level. For example, a microphone may determine an ambient or background noise level that is used to determine the volume level of the play back of an audio file.

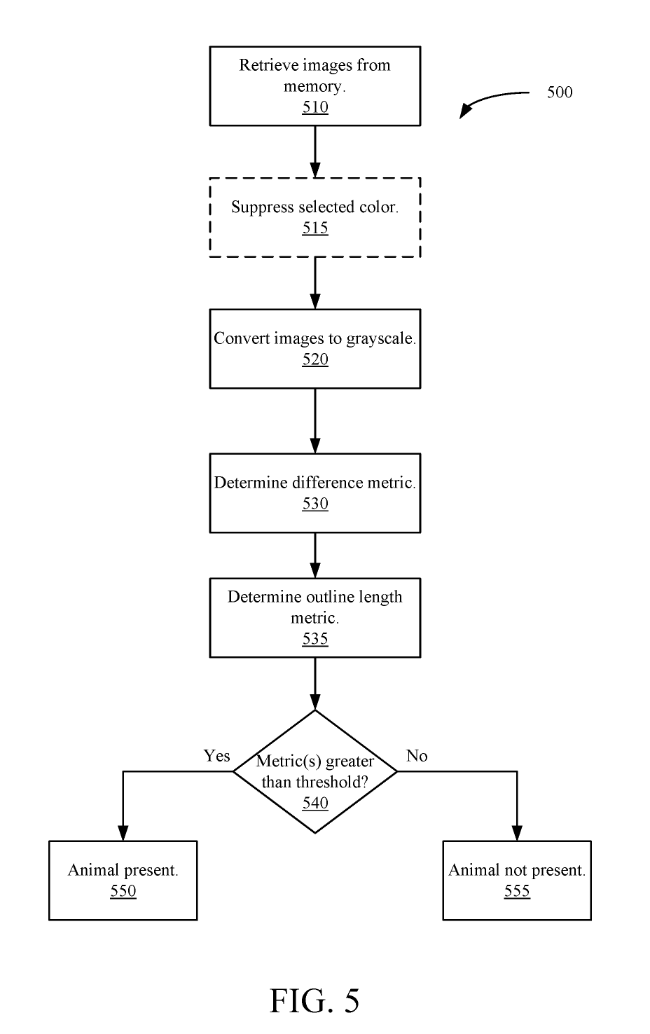

FIG. 5 shows an illustrative flow chart depicting an operation 500 for processing images and determining an animal presence. In some implementations, the operation 500 may be associated with, or be related to, the operation to process images and determine an animal presence 308 of FIG. 3. Referring also to FIG. 1, captured images may be retrieved from memory (510). For example, images previously stored in the image memory 142 may be retrieved by the processor 130. In some implementations, two images are retrieved. In some other implementations, more than two images are retrieved. Next, a color is suppressed (515). (This is an optional step as indicated by dashed lines in FIG. 5. The user may select a color to be suppressed (removed) from an image to emphasis any animal presence. For example, the user may select a plurality of shades of green to remove from the images. Green may be selected because of the prevalence of green in outdoor areas.

Next, the retrieved (and optionally color suppressed) images are converted to grayscale (520). For example, all color information remaining in the images may be removed leaving black and white information. Next, a difference metric may be determined from the resulting images (530). In some implementations, a difference between images may be computed. For example, each image may have i rows and j columns and be represent as IMG_{i,j}. (Each image may have i*j pixels). Therefore, a first image may be described by IMG(1)_{i,j} and a second image may be described by IMG(2)_{i,j}. A difference between each pixel of the images may be calculated as delta=IMG(1)_{i,j}−IMG(2)_{i,j} for all i and j. The difference metric may be defined to the absolute value of the delta.

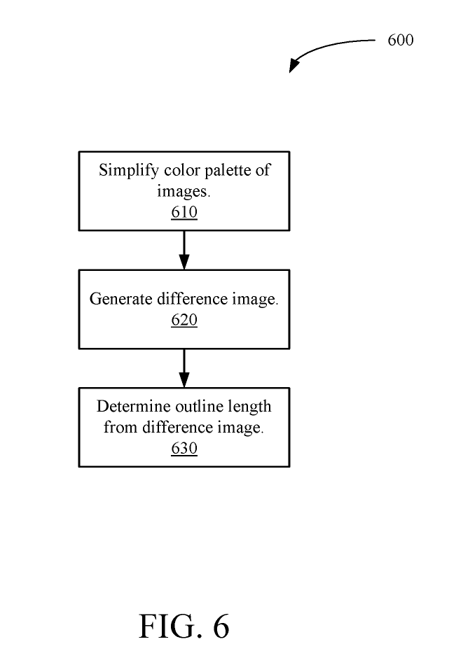

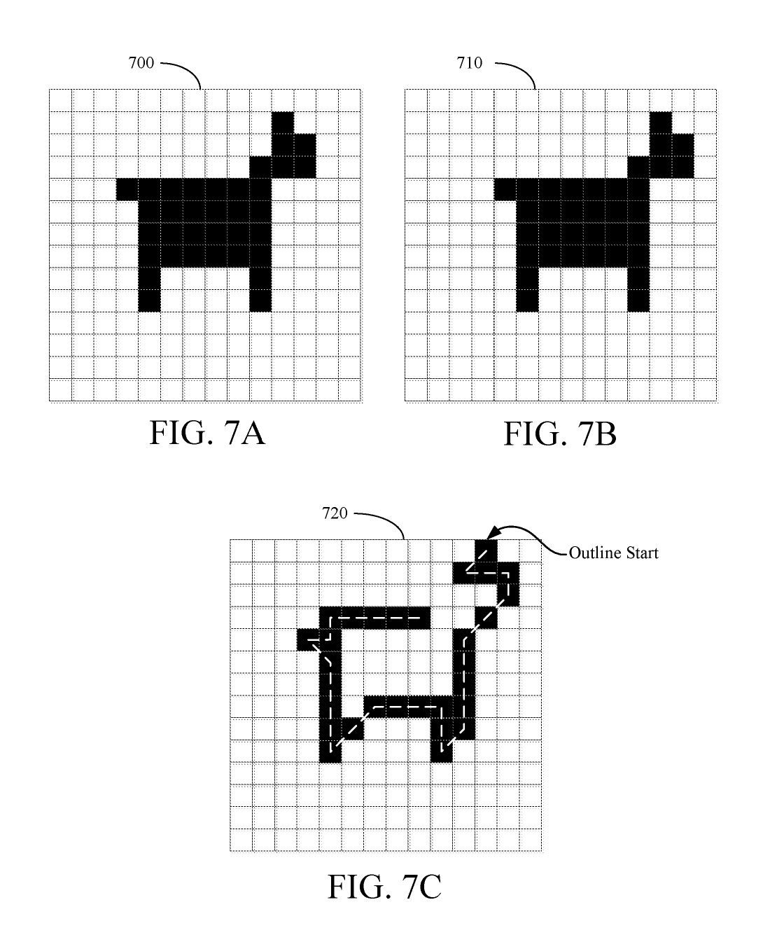

Next, an outline length metric may be determined (535). The outline length metric determines the length (in pixels) of a captured image. Details associated with determining the outline length metric are described in more detail below in conjunction with FIGS. 6A-6C and FIGS. 7A-7B. Next, the difference metric is compared to a threshold (540). In some implementations, the threshold may be determined empirically. If the difference metric (and/or the outline length metric) is greater than the threshold, then an animal is determined to be present (550). On the other hand, if the difference metric and/or the outline length metric is smaller than the threshold, then an animal is determined to not be present (555).

FIG. 6 shows an illustrative flow chart depicting an operation 600 for determining an image outline metric. In some implementations, the operation 600 may be associated with, or be related to, the operation to determine the outline image metric 535 of FIG. 5. The operation begins as the animal deterrent device 100 simplifies the color palette of the captured images (610). Color information may be unnecessary and/or may cause erroneous results. In some implementations, a pixel value (including both luminance and chrominance information) may be compared to a pixel value threshold to determine a simplified pixel that may bi-valued (e.g., may be either a black pixel or a white pixel).

Next, the animal deterrent device 100 determines a difference (delta) image (620). Each pixel in a first simplified color palette image is compared to a corresponding pixel in a second simplified color palette image. If the corresponding pixels of the first and second images are the same (are both black or are both white), then the corresponding pixel in the difference image is determined to be a first value (e.g., determined to be white). If, on the other hand, the corresponding pixels of the first and second images are different (a first pixel is black and a second pixel is white), then the corresponding pixel in the difference image is determined to be a second value (e.g., determined to be black). (Note that the colors associated with the first value and the second value are arbitrary and the example values of black and white are meant to be illustrative and are not meant to be limiting.)

Next, the animal deterrent device 100 determines an outline length (630). In some implementations, the outline length is determined by finding the longest run of adjacent second valued pixels in the difference image. In the example difference image described with respect to operation 620, the second valued pixels are black. Therefore, the outline length is determined by finding the longest run of adjacent black pixels. In some aspects an “adjacent” pixel may be defined to be a pixel above, below, to the right, to the left or in a diagonal corner.

FIGS. 7A-7C are simplified images to illustrate an example implementation of the operation to determine an outline length metric as described with respect to FIG. 6. To begin, each of FIGS. 7A-7C represents an image of pixels arranged in rows and columns. For ease of explanation, the example images are composed of a small number of pixels. Persons having ordinary skill in the art will appreciate that the images may be composed of any feasible number of pixels.

FIG. 7A depicts a first image 700 of an animal. Referring also to FIG. 1, the first image 700 may be captured by the image capture subsystem 124 and stored in the image memory 142. Referring also to FIG. 6, the first image 700 may have a simplified color palette (operation 610). In this example, the first image 700 may be an animal (a black animal on a white background). FIG. 7B is a second image 710 of the animal (captured, for example, a fixed time after the first image 700). The second image 710 is also shown with a simplified color palette. The animal in the second image 710 may have moved with respect to the animal in the first image 700.

FIG. 7C is a third image 720 based on a difference between the first image 700 and the second image 710. In some implementations, the third image 720 may be determined in accordance with the operation to determine the outline length 630 of FIG. 6. The third image 720 may sometimes be referred to as a difference (delta) image. Any pixel differences between the first image 700 and the second image 710 are depicted as a first (black) pixel in the corresponding pixel of the third image 720. If there are no pixel differences between the first image 700 and the second image 710, then the corresponding pixel in the third image 720 is shown as a second (white) pixel. In other implementations, the first pixel may be a white pixel and the second pixel may be a black pixel. In the third image 720, an outline of the animal is shown as a continuous (adjacent) run of black pixels. One implementation of the outline length metric may be computed by determining the longest run of adjacent black pixels in the third image 720. In the example third image 720, the outline length metric is 14. (For reference, an outline start pixel is denoted in the third image 720 and an outline path is shown in white dashed lines.) The determined outline length metric may be compared to a threshold as described with respect to the operation 540 of FIG. 5

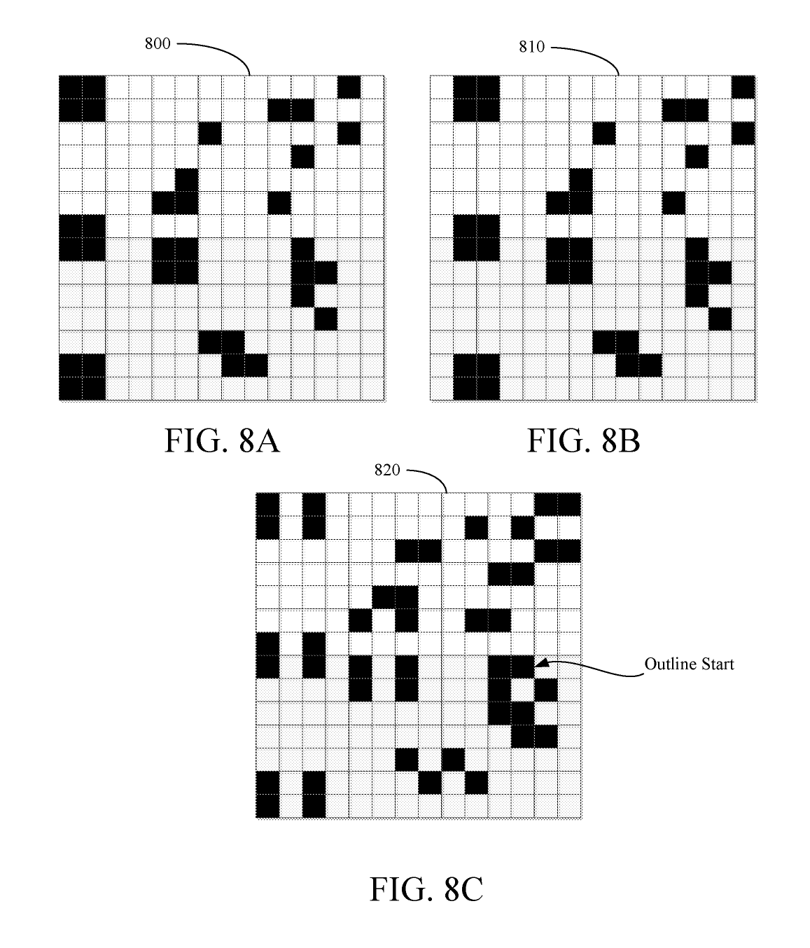

FIGS. 8A-8C are simplified images to illustrate another example implementation of a determination of an outline length metric as described with respect to FIG.6. In contrast to the animal shapes of the FIGS. 7A and 7B, a fourth image 800 and a fifth image 810 show clusters of shapes. Similar to the first image 700 and the second image 710, the fourth image 800 and the fifth image 810 may have a simplified color palette. The shapes of the fifth image 710 may have moved with respect to the shapes of the fourth image 700.

A sixth image 720 shows a difference image. The difference image may be determined as described with respect to the operation to determine the outline length 630 of FIG. 6. The outline length metric based on the sixth image 720 is 8. The determined outline length metric may be compared to a threshold as described with respect to the operation 540 of FIG. 5

Although no clear animal shape or image is shown in the fourth image 800 and the fifth image 810, the motion of an object within the images may be detected and verified from the outline length.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described throughout. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-chip or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

What is claimed is:

1. An animal deterring apparatus comprising:
a first subsystem to detect heat and motion within a predetermined distance of the apparatus;
a second subsystem to verify an animal presence via an image processing subsystem in response to the detection of heat and motion via the first subsystem; and
a third subsystem to repel an animal by a playback of audio files in response to the verification of an animal presence.

2. The apparatus of claim 1, wherein the second subsystem is to:
capture a first image and a second image;
determine a metric based at least in part on the first image and the second image; and
verify the animal presence when the metric is greater than a threshold.

3. The apparatus of claim 2, wherein the metric is further based at least in part on a sum of an absolute value of a difference between corresponding pixels in the first image and the second image.

4. The apparatus of claim 2, wherein the metric is further based at least in part on a number of similarly valued adjacent pixels in a third image, the third image based on a difference between the first image and the second image.

5. The apparatus of claim 2, wherein second subsystem further comprises:
a detector to detect ambient light; and
a light source controlled at least in part by the detected ambient light.

6. The apparatus of claim 5, wherein the light source is an infrared light source.

7. The apparatus of claim 2, wherein the second subsystem is to suppress one or more colors within the first image and the second image.

8. The apparatus of claim 1, wherein the second subsystem further comprises a tilt detector to detect motion of the apparatus.

9. A method for detecting and repelling animals comprising:
detecting heat and motion;
verifying an animal presence via an image processing subsystem in response to detecting of heat and motion; and
repelling an animal by playing back audio files in response to the verifying of an animal presence.

10. The method of claim 9, wherein the verifying further comprises:
capturing a first image and a second image;
determining a metric based at least in part on the first image and the second image; and
verifying the animal presence when the metric is greater than a threshold.

11. The method of claim 10, wherein the metric if further based at least in part on a sum of an absolute value of a difference between corresponding pixels in the first image and the second image.

12. The method of claim 10, wherein the metric is further based at least in part on a number of similarly valued adjacent pixels in a third image, the third image based on a difference between the first image and the second image.

13. The method of claim 10, further comprising:
detecting ambient light; and
controlling a light source based at least in part on the detected ambient light.

14. The method of claim 13, wherein the light source is an infrared light source.

15. The method of claim 10, further comprising:
suppressing one or more colors with the first image and the second image.

16. The method of claim 9, wherein the verifying further comprises detecting a motion via a tilt detector.

17. A method for determining a metric to verify an animal presence comprising:
capturing a first and a second image;
determining a difference image based on the first and the second images; and
determining an outline length based on similarly valued adjacent pixels of the difference image.

18. The method of claim 17, wherein the difference image is further determined by:
comparing a first pixel in the first image to a corresponding second pixel in the second image;
assigning a first pixel value to a pixel corresponding to the first pixel and the second pixel if the first pixel is similarly valued to the second pixel; and
assigning a second pixel value to the pixel corresponding to the first pixel and the second pixel if the first pixel is not similarly valued to the second pixel.

19. The method of claim 17, further comprising:
simplifying a color palette of the first image and the second image prior to determining the difference image.

20. The method of claim 17, further comprising:
comparing the outline length to a threshold; and
verifying the presence on the animal when the outline length is greater than the threshold.
